(19) United States
(12) Patent Application Publication
(10) Pub. No.: US 2010/0118311 A1
(43) Pub. Date: May 13, 2010

(54) METHOD OF DETECTING AN ABNORMAL SEMICONDUCTOR DEVICE USING A STANDARD OPTICAL CRITICAL DIMENSION DATABASE

(75) Inventor: Dong-Hyun HAN, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/615,515

(22) Filed: Nov. 10, 2009

(30) Foreign Application Priority Data
Nov. 12, 2008 (KR) 10-2008-0112048

(51) Int. Cl. G01N 21/55; G01N 21/88

(52) U.S. Cl. 356/448; 356/237.5

(57) ABSTRACT

In a method of detecting an abnormal semiconductor device, a pattern on a semiconductor substrate may be irradiated by a light. A reflected light from the pattern may be detected. Spectrum data of the reflected light may be compared with a predetermined reference spectrum data that is obtained from a test pattern of a reference sample. Whether the pattern is normal or not may be determined based on comparison results. Thus, the abnormal semiconductor device may be recognized in the processes for manufacturing the semiconductor device to prevent the subsequent processes from being performed on the abnormal semiconductor device. As a result, the yield of normal or non-defective semiconductor devices may be improved.

### CROSS-REFERENCE TO RELATED APPLICATIONS

This application claims the benefit under 35 USC §119 to Korean Patent Application No. 2008-112048, filed on Nov. 12, 2008, in the Korean Intellectual Property Office (KIPO), the contents of which are herein incorporated by reference in their entirety.

### BACKGROUND

1. Field of the Invention

The present general inventive concept relates to a method of detecting an abnormal semiconductor device that may have a misaligned connection between stacked conductive layers. More particularly, the present general inventive concept relates to a method of detecting an abnormal semiconductor device using an optical critical dimension database of a specific process by each of semiconductor devices, and a system for manufacturing a semiconductor device using the method.

2. Description of the Related Art

Recently, as semiconductor memory devices have become highly integrated, the area of a unit cell in semiconductor memory devices may be significantly reduced. Thus, the width of patterns and the gap between the patterns in the semiconductor memory devices may be greatly narrowed. In contrast, electrical characteristics of the semiconductor memory devices must still be maintained in spite of the small area of the unit cell.

Particularly, the width of a contact hole or a wiring is closely related to resistance characteristics. Thus, in order to meet the electrical characteristics of the highly integrated semiconductor memory devices, it may be required to align an upper wiring with a lower wiring.

Referring to FIGS. 1 to 3, semiconductor devices include lower layers and upper layers connected with the lower layers. The semiconductor devices may have desired electrical characteristics by accurately aligning the upper layers with the lower layers.

However, as shown in FIG. 1, when a lower layer 30 is not precisely connected with an upper layer 40, the semiconductor device may not have the desired electrical characteristics.

Further, as shown in FIG. 2, when a connecting wiring 70 is misaligned with a lower layer 60 and an upper layer 75, a malfunction may be generated in the semiconductor device.

As shown in FIG. 3, when a plug 98 is shifted from a gate structure 94, the semiconductor device may have inferior characteristics.

Here, when the abnormal semiconductor device may be detected in processes for manufacturing the semiconductor device, subsequent processes may not be advanced to prevent a manufacture cost of the semiconductor device from being generated. However, when the abnormal semiconductor device may be detected in an electrical die sorting (EDS) process, the cost for manufacturing the semiconductor device may be used wastefully.

### SUMMARY

Exemplary embodiments provide a method of detecting an abnormal semiconductor device using an optical critical dimension.

Additional aspects and utilities of the present general inventive concept will be set forth in part in the description which follows and, in part, will be obvious from the description, or may be learned by practice of the general inventive concept.

Exemplary embodiments provide a system for manufacturing a semiconductor device using the above-mentioned method.

The foregoing and/or other features and utilities of the present general inventive concept may be achieved by providing a method of detecting an abnormal semiconductor device using an optical critical dimension database. In the method of detecting the abnormal semiconductor device, a light may be irradiated to a pattern on a semiconductor substrate. A reflected light from the pattern may be detected. Spectrum data of the reflected light may be compared with a predetermined reference spectrum data that is obtained from a test pattern of a reference sample. Whether the pattern is normal or not may be determined based on comparison results.

In some exemplary embodiments, the spectrum data and the reference spectrum data may be obtained from optical critical dimensions of the pattern and the test pattern.

In some exemplary embodiments, the reference spectrum data may be obtained from the test pattern on which a normal process is performed.

In some exemplary embodiments, the method may further include suspending a subsequent process on the semiconductor substrate that is determined to be abnormal.

The foregoing and/or other features and utilities of the present general inventive concept may be achieved by providing a system for manufacturing a semiconductor device. The system may include a research area, a computation management area, a process management area and a production area. The research area may include a plurality of personal terminals. The computation management area may include a server that may store a reference spectrum data of a reference sample. The process management area may include management units that may measure an optical critical dimension of the semiconductor device to obtain a spectrum data of the semiconductor device. The production area may include equipments that may perform processes for manufacturing the semiconductor device.

In some exemplary embodiments, the management units may compare the spectrum data of the semiconductor device with the reference spectrum data.

In some exemplary embodiments, the server may store data of all of the semiconductor devices, which are loaded into the production area, having a vertical structure.

In some exemplary embodiments, the spectrum data may be displayed on the personal terminals.

In some exemplary embodiments, the personal terminals may include a notebook personal computer, an ultra mobile personal computer or a portable multimedia player.

In some exemplary embodiments, the personal terminals may be connected with the server by wire or wireless.

According to some exemplary embodiments, an abnormal semiconductor device may be recognized in the processes for manufacturing the semiconductor device to prevent the subsequent processes from being performed on the abnormal semiconductor device. As a result, a yield of a semiconductor device may be remarkably improved.

The foregoing and/or other features and utilities of the present general inventive concept may be achieved by providing a method of detecting an abnormal semiconductor device, the method including irradiating a test pattern on a semiconductor substrate by a light, detecting a reflected light from the test pattern, comparing spectrum data of the reflected light with a predetermined reference spectrum data that is obtained from a test pattern of a reference sample, testing an additional semiconductor substrate, and determining whether the pattern is normal or not based on comparison results.

The spectrum data and the reference spectrum data may be obtained from optical critical dimensions of the pattern and the test pattern.

The reference spectrum data is obtained from the test pattern on which a normal process is performed.

The method may further comprise suspending a subsequent process on the semiconductor substrate that is determined to be abnormal.

The foregoing and/or other features and utilities of the present general inventive concept may be achieved by providing an apparatus to test a semiconductor device, the apparatus including a laser to irradiate a semiconductor device having a plurality of layers, a light detector to detect reflected light from the semiconductor device, and a computer to compare spectrum data of the reflected light to stored optical critical dimension data and to determine whether the semiconductor device is normal or abnormal.

The computer may include an acceptable range of spectrum values to be normal when comparing the spectrum data of the reflected light to stored optical critical dimension data.

The computer may update the stored optical critical dimension data based upon the reflected light.

The foregoing and/or other features and utilities of the present general inventive concept may be achieved by providing a system of manufacturing a semiconductor device, the system including a test tool to test a semiconductor device, the test tool including a laser to irradiate a semiconductor device having a plurality of layers, a light detector to detect reflected light from the semiconductor device, and a computer to compare spectrum data of the reflected light to stored optical critical dimension data and to determine whether the semiconductor device is normal or abnormal, and a process unit to further manufacture the semiconductor device when the semiconductor device is determined to be normal.

The computer may include an acceptable range of spectrum values to be normal when comparing the spectrum data of the reflected light to stored optical critical dimension data.

The computer may update the stored optical critical dimension data based upon the reflected light.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

Exemplary embodiments will be more clearly understood from the following detailed description taken in conjunction with the accompanying drawings. FIGS. 1 to 13 represent non-limiting, exemplary embodiments as described herein.

FIG. 1 is a cross-sectional view illustrating an abnormal semiconductor device having a metal wiring;

FIG. 2 is a cross-sectional view illustrating an abnormal semiconductor device having a plug;

FIG. 3 is a cross-sectional view illustrating an abnormal semiconductor device having a gate electrode and a plug;

FIG. 4 is a cross-sectional view illustrating a mechanism of reflected lights in a semiconductor device that has metal wirings and insulating interlayers on a semiconductor substrate to which a laser is irradiated;

FIG. 5 is a graph showing a spectrum of the reflected lights in FIG. 4;

FIG. 6 is a flow chart illustrating a method of detecting an abnormal semiconductor device in accordance with some exemplary embodiments;

FIG. 7 is a flow chart illustrating a method of detecting an abnormal semiconductor device in accordance with some exemplary embodiments;

FIG. 8 is a graph showing a spectrum of reflected lights that are irradiated in an X-direction;

FIG. 9 is a graph showing a spectrum of reflected lights that are irradiated in a Y-direction;

FIG. 10 is a block diagram illustrating a system to manufacture a semiconductor device;

FIGS. 11 and 12 are cross-sectional views illustrating normal semiconductor devices from which standard sample data is obtained; and

FIG. 13 is a block diagram illustrating a test tool used in manufacturing a semiconductor device.

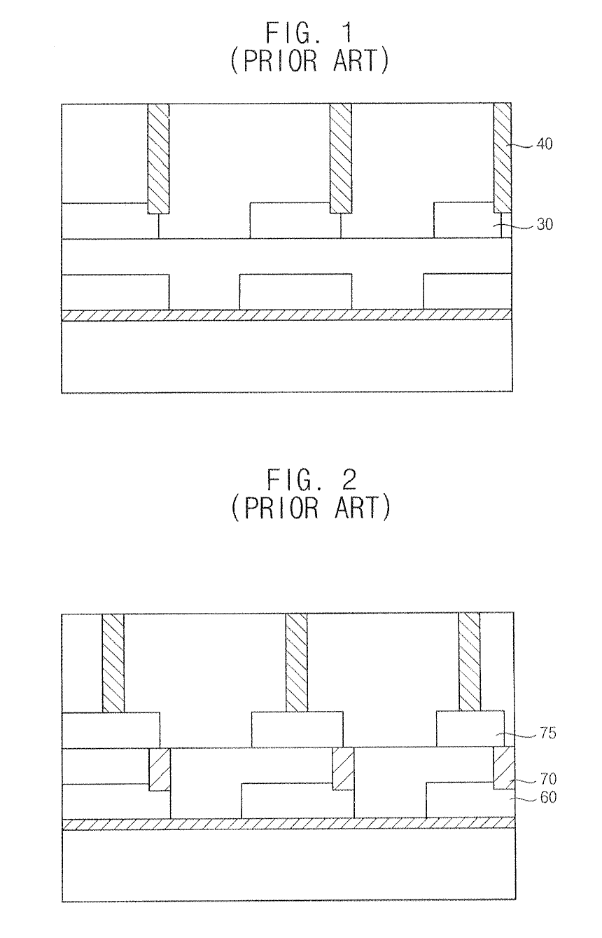

### DETAILED DESCRIPTION OF THE EMBODIMENTS

Various exemplary embodiments will be described more fully hereinafter with reference to the accompanying drawings, in which some exemplary embodiments are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments will be explained in detail with reference to the accompanying drawings.

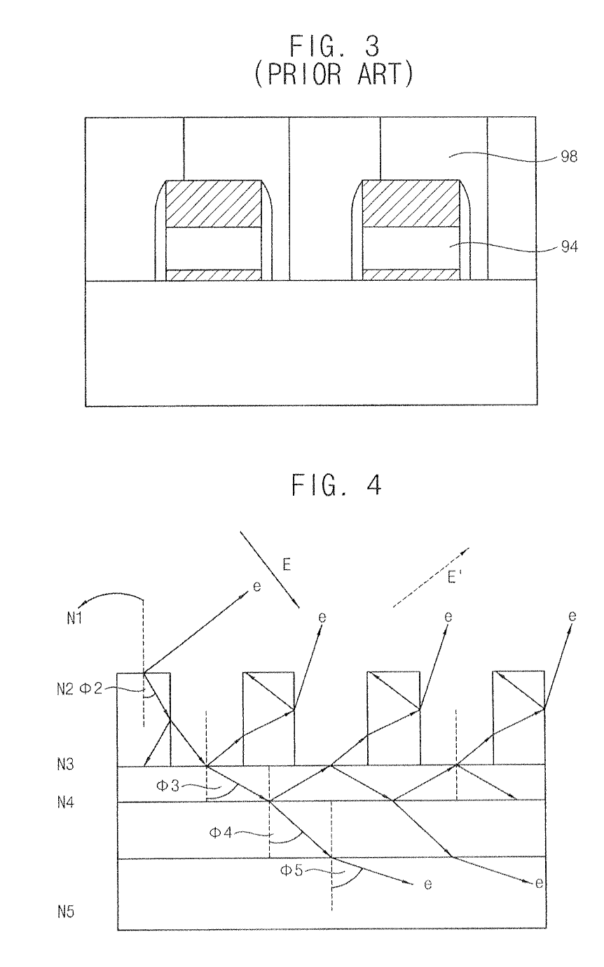

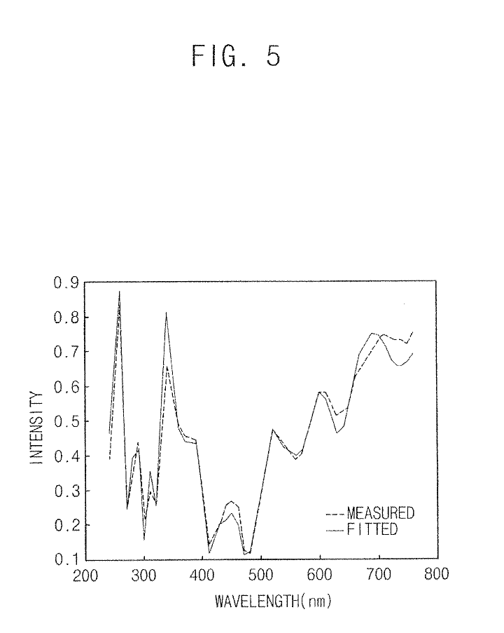

FIG. 4 is a cross-sectional view illustrating a method of measuring an optical critical dimension with a mechanism of reflected light in a semiconductor device that has metal wirings and insulating interlayers on a semiconductor substrate which is irradiated by a laser, and FIG. 5 is a graph showing a spectrum of the reflected lights in FIG. 4.

Referring to FIG. 4, metal wirings, conductive layers, insulating interlayers, etc., may be formed on a semiconductor substrate.

When the semiconductor substrate is irradiated by a light E, the light E may be reflected, refracted and diffracted in accordance with thicknesses, shapes, kinds, etc., of the metal wirings, conductive layers and the insulating interlayers to generate a reflected light E′.

Particularly, when the semiconductor substrate is irradiated by the light E at an incident angle φ2 with respect to a vertical axis (dotted line), the light E may be partially reflected or may go straight and then be reflected when used to detect the reflected light E′.

Here, the reflected light E′ may be shown as influenced by reflected angles φ3, φ4 and φ5 in accordance with the thicknesses, reflectivities N1, N2, N3, N4 and N5, shapes and sizes of the layers.

The paths of the light E and the reflected light E′ in FIG. 4 may be obtained using a O-order diffracted light with respect to the metal wiring, the conductive layers and the insulating interlayers on the semiconductor substrate.

Referring to FIG. 5, when a pattern on the semiconductor substrate on which a specific process may be performed may be measured, data of the pattern may be shown on a monitor in accordance with kinds, thicknesses, shapes, etc., of the pattern.

An optical critical dimension (OCD) metrology may measure a vertical profile of the pattern using a reflectivity and a phase of a diffracted light through the pattern.

The vertical profile of the pattern may be displayed on the monitor based on parameters of the layers on the semiconductor substrate such as dispersion, width, step, incident angle, etc.

The displayed spectrum data may be shown as intensity and phase plotted by wavelength.

Here, according to a conventional method, a critical dimension of a single layer may be measured using a scanning electron microscope (SEM). Thus, a profile of stacked layers may not be measured using the conventional method.

In contrast, according to the above-mentioned optical critical dimension (OCD) metrology, the spectrum data of the optical critical dimension as a standard sample of the pattern on the semiconductor substrate on which a specific process may be normally performed may be obtained.

An allowable range by devices may be determined by generating a database of the spectrum data of the optical critical dimension.

Particularly, optical standard samples by devices may be prepared in accordance with various conditions in processes for manufacturing the semiconductor device. The optical standard samples by devices may be used in manufacturing each of the semiconductor devices.

The sample data by devices may be stored in a main computer for managing the processes. The main computer may be connected with a personal terminal and a monitoring system.

For example, when the semiconductor device includes a DRAM device, the optical standard sample data for the DRAM device may be used for monitoring processes from an initial operation to the present operation for forming a metal wiring after forming a capacitor.

Here, a selected semiconductor device may include a test pattern from which an optical critical dimension may be obtained. A spectrum data of the optical critical dimension may be obtained from the test pattern.

The spectrum data of the optical critical dimension in the main computer system may be compared with actual spectrum data of the DRAM device to determine whether a subsequent process may be advanced or not.

Here, when the actual spectrum data of the DRAM device is compared with the spectrum data of the optical critical dimension, the actual spectrum data may not be identical to the spectrum data of the optical critical dimension due to some process variables. Therefore, an abnormal semiconductor device may be determined by proximity of the spectrum data.

In a conventional method, a failed or defective semiconductor substrate between processes may not be recognized because the critical dimension may be measured using the SEM. Thus, an abnormal semiconductor device may only be recognized in an electrical die sorting (EDS) process after processes for manufacturing the semiconductor device. As a result, subsequent processes may be still performed on the abnormal semiconductor device.

In contrast, the method of this exemplary embodiment of the present general inventive concept may recognize the vertical profile of the patterns using the optical critical dimension. Thus, an abnormal semiconductor device may be recognized in the processes for manufacturing the semiconductor device to prevent the subsequent processes from being performed on the abnormal semiconductor device. As a result, the number of normally manufactured semiconductor devices may be more quickly recognized, so that product amounts of the semiconductor device may be effectively controlled.

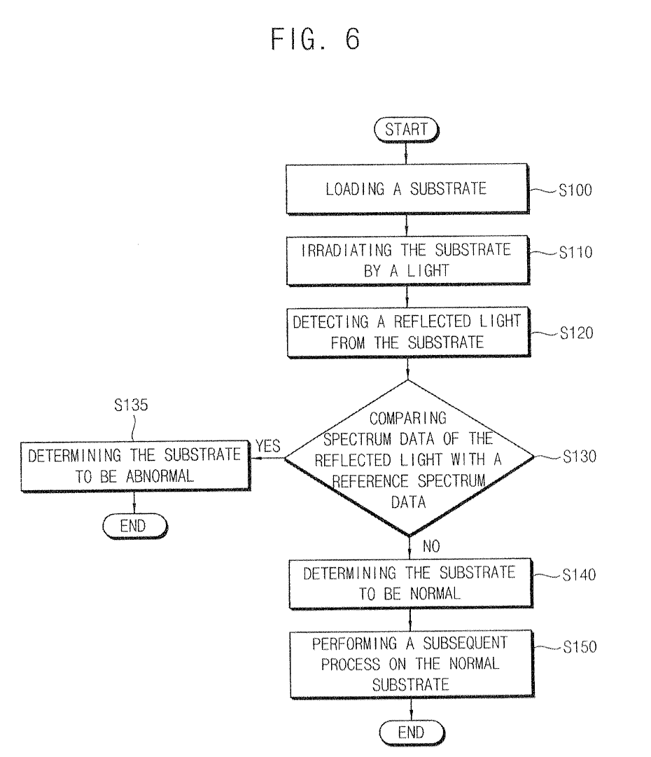

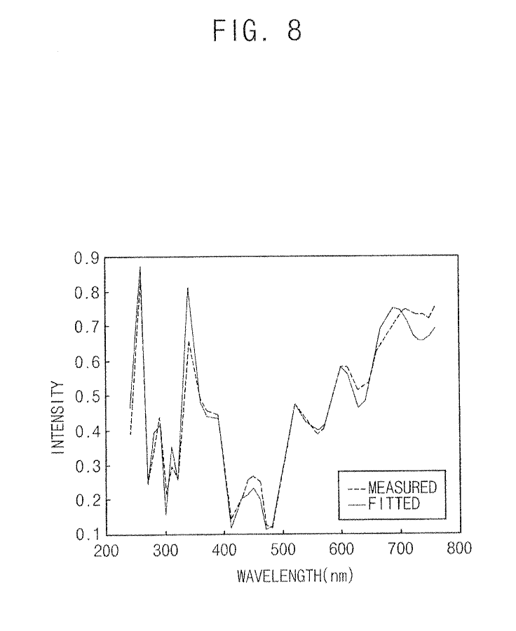

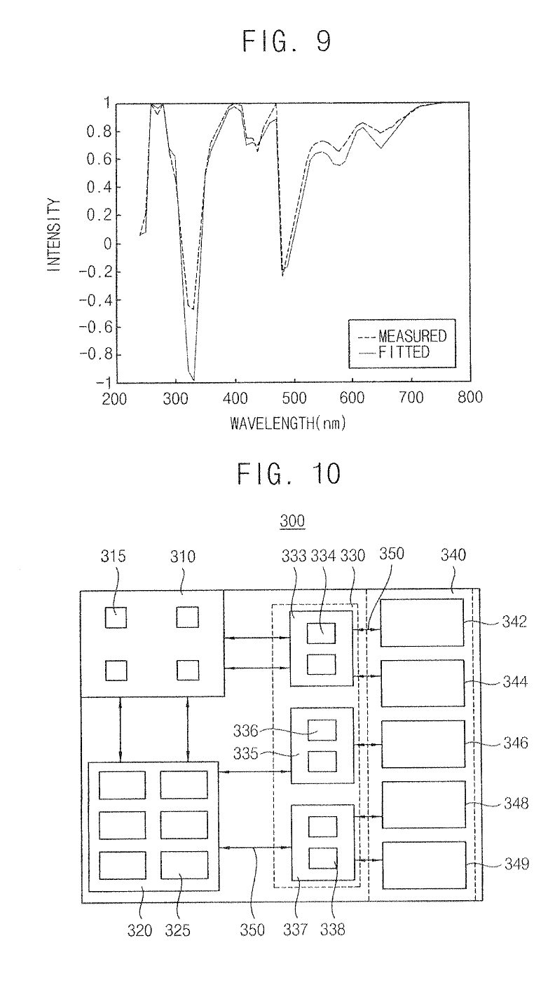

FIG. 6 is a flow chart illustrating a method of detecting an abnormal semiconductor device and manufacturing a semiconductor device in accordance with an exemplary embodiment of the present general inventive concept, FIG. 8 is a graph showing a spectrum of reflected lights that are irradiated in an X-direction, and FIG. 9 is a graph showing a spectrum of reflected lights that are irradiated in a Y-direction.

A method of manufacturing a semiconductor device using an optical critical dimension may use a standard sample database of a specific process by devices.

Further, in order to measure the optical critical dimension in the specific process, a test pattern may be formed on a semiconductor substrate.

The test pattern may include vertically stacked metal wirings, conductive layers, insulating interlayers, etc. The test pattern may be irradiated by a light. A reflected light may be reflected from the test pattern in accordance with vertical profiles, which are properties of the vertically stacked layers.

Further, the test pattern may have a variable shape in accordance with positions of the semiconductor substrate. Thus, the test pattern may be arranged on various positions of the semiconductor substrate such as an upper region, a lower region, a left region, a right region, etc.

The semiconductor devices may be manufactured by performing various processes, such as a photolithography process, an etching process, a deposition process, a planarization process, etc., on the semiconductor substrates. The processes may be carried out by commands of computers or robots.

Referring to FIG. 6, in operation S100, a semiconductor substrate on which a specific process may be performed may be loaded into a tool for measuring the optical critical dimension.

In an exemplary embodiment of the present general inventive concept, the loaded semiconductor substrate may have vertically stacked layers to be tested. Thus, a photoresist pattern may be formed on the semiconductor substrate. The layers may be etched using the photoresist pattern as an etch mask to form a layer pattern. The photoresist pattern may then be removed by an ashing process and/or a stripping process.

In some exemplary embodiments, the tool, a program, a server, etc., which may be used for measuring the optical critical dimension, may be expensive. Thus, the process for measuring the optical critical dimension may be preferably performed on only the vertically stacked layers on the semiconductor substrate.

In some exemplary embodiments, a gate electrode, a bit line, a metal wiring, etc., may be additionally formed on the semiconductor substrate. The optical critical dimension of the semiconductor substrate having the above-mentioned structure may be effectively measured.

Alternatively, in a process for forming a complicated structure without a process margin, the process for measuring the optical critical dimension may be performed before forming the metal wiring.

In operation S110, the test pattern on the semiconductor substrate may be irradiated by a light.

In an exemplary embodiment of the present general inventive concept, the light may be generated from a short wavelength light source, a composite wavelength light source, etc.

In some exemplary embodiments, the light may be irradiated by wavelength through a monochromater. Thus, reflected lights by wavelengths may be detected, so that reflectivities may be measured.

Further, the reflectivities and extinction coefficients of the layers may be different from each other in accordance with the kinds of layers. Thus, in order to obtain various data, the composite wavelength light rather than the short wavelength light may be preferably used.

In operation S120, the light may be reflected from the test pattern. The reflected light may then be detected.

As shown in FIGS. 8 and 9, mean values of data of the reflected light by wavelength may be calculated by regions irradiated by the light. The mean values may be shown as intensities and phases.

The intensities by wavelength may be different from each other. Thus, an intensity of the semiconductor substrate may be measured. An optical critical dimension of a pattern may be obtained from the graphs in FIGS. 8 and 9. Therefore, a vertical profile of the pattern may be recognized.

The above-mentioned processes may be repeatedly performed in an X-direction and a Y-direction to obtain the graphs in FIGS. 8 and 9. A three-dimensional shape of the pattern may be obtained from the graphs in FIGS. 8 and 9.

Data of the reflected light from the upper test pattern, the lower test pattern, the left test pattern and the right test pattern may be obtained using the above-mentioned manner.

In operation S130, the data of the reflected light may be compared with the predetermined reference data.

In an exemplary embodiment of the present general inventive concept, the reference data of the optical critical dimension by devices may be stored in the main computer.

The actual data of the optical critical dimension obtained from the selected semiconductor substrate may be compared with the reference data of the optical critical dimension by devices.

Here, the actual data may not be identical to the reference data of the optical critical dimension due to some process variables. Therefore, an abnormal semiconductor device may be determined by proximity of the data.

In operation S135, when the actual data of the optical critical dimension obtained from the selected semiconductor substrate is different from the reference data of the optical critical dimension, the selected semiconductor substrate is determined to be abnormal. A subsequent process may not be performed on the semiconductor substrate determined to be abnormal.

In operation S140, when the actual data of the optical critical dimension obtained from the selected semiconductor substrate is similar to the reference data of the optical critical dimension within an allowable range, the selected semiconductor substrate is determined to be normal. A subsequent process may be performed on the semiconductor substrate determined to be normal.

In operation S150, subsequent processes may be performed on the semiconductor substrate determined to be normal, thereby completing the semiconductor device.

According to this exemplary embodiment of the present general inventive concept, the abnormal semiconductor device may be determined in the processes using the optical critical dimension database. Thus, performing the subsequent processes on the abnormal semiconductor device may be prevented. As a result, the yield of normal or non-defective semiconductor devices may be remarkably improved.

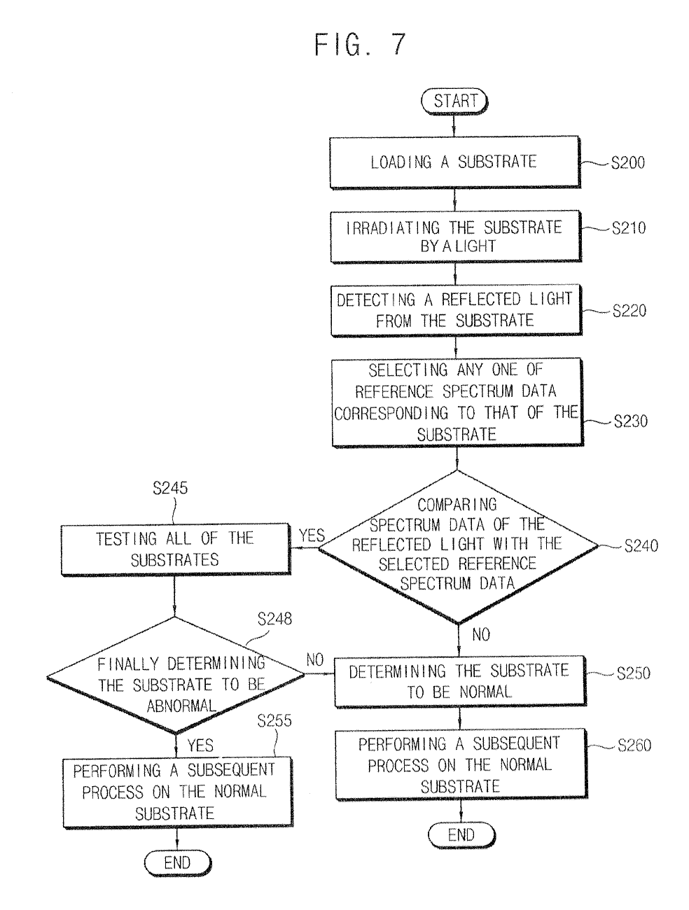

FIG. 7 is a flow chart illustrating a method of detecting an abnormal semiconductor device in accordance with an exemplary embodiment of the present general inventive concept.

Here, a method of this exemplary embodiment includes processes substantially the same as those of the method illustrated with reference to FIG. 6 except that a final determination process may be performed by a worker and other processes may be performed by a system.

Each semiconductor substrate may receive an identification number. After performing a specific process on the semiconductor substrate, the semiconductor substrate may be transferred to a monitoring room. A robot may be loaded into a measuring tool.

In operation S200, the semiconductor substrate on which a specific process may be performed may be loaded into the tool for measuring the optical critical dimension.

In an exemplary embodiment of the present general inventive concept, the loaded semiconductor substrate may have vertically stacked layers to be tested. Thus, a photoresist pattern may be formed on the semiconductor substrate. The layers may be etched using the photoresist pattern as an etch mask to form a layer pattern. The photoresist pattern may then be removed by an ashing process and/or a stripping process.

In some exemplary embodiments, a gate electrode, a bit line, a metal wiring, etc., may be additionally formed on the semiconductor substrate. The optical critical dimension of the semiconductor substrate having the above-mentioned structure may be effectively measured.

Alternatively, in a process for forming a complicated structure without a process margin, the process for measuring the optical critical dimension may be performed before forming the metal wiring.

In operation S210, the test pattern on the semiconductor substrate may be irradiated by a light.

In an exemplary embodiment of the present general inventive concept, the light may be generated from a short wavelength light source, a composite wavelength light source, etc.

In some exemplary embodiments, the light may be irradiated by wavelength through a monochromater. Thus, reflected lights by wavelengths may be detected, so that reflectivities may be measured.

Further, the reflectivities and extinction coefficients of the layers may be different from each other in accordance with the kinds of layers. Thus, in order to obtain various data, the composite wavelength light rather than the short wavelength light may be preferably used.

In operation S220, the light may be reflected from the test pattern. The reflected light may then be detected.

Intensities by wavelength may be different from each other. Thus, an intensity of the semiconductor substrate may be measured. An optical critical dimension of a pattern may be obtained. Therefore, a vertical profile of the pattern may be recognized.

The above-mentioned processes may be repeatedly performed in an X-direction and a Y-direction to obtain a three-dimensional shape of the pattern.

The stacked layers of the pattern may have different properties. Thus, the reflected light from the stacked layers may be different from each other in accordance with the wavelengths. The vertical profile of the pattern may be recognized from the optical critical dimensions in the X-direction and the Y-direction.

Alternatively, spectrum signals of the reflected light may be compared with each other using the optical critical dimension to determine the semiconductor substrate to be normal or not.

In an exemplary embodiment of the present general inventive concept, the spectrum data of the optical critical dimension obtained from the actual semiconductor substrate may not be identical to the reference data of the optical critical dimension due to some process variables. Therefore, an allowable range of the data for determining the semiconductor substrate to be normal may be set in the system. Thus, the system may automatically determine a semiconductor device to be normal or not.

In operation S230, because the system may recognize the loaded semiconductor substrate, any one of the reference data by device corresponding to the selected semiconductor substrate may be selected.

When the system detects the reflected light, the system may select any one of the reference data corresponding to the selected semiconductor substrate. The selected reference data may then be compared with the spectrum data of the reflected light.

In an exemplary embodiment of the present general inventive concept, the reference data may be prepared and managed before manufacturing the semiconductor device. However, because the reference data may vary in accordance with process conditions of the semiconductor device, the optical critical dimension database may be periodically corrected.

In operation S240, the data of the reflected light may be compared with the predetermined reference data.

In an exemplary embodiment of the present general inventive concept, the reference data of the optical critical dimension by devices may be stored in the system.

The actual data of the optical critical dimension obtained from the selected semiconductor substrate may be compared with the reference data of the optical critical dimension by devices.

In operation S245, when the actual data of the optical critical dimension obtained from the selected semiconductor substrate may be different from the reference data of the optical critical dimension, a test process may be performed on other semiconductor substrates as well as the selected semiconductor substrate so as to recognize problems due to only the selected semiconductor substrate or the system malfunction.

In operation S248, test results may be transferred to the system. The worker may determine the semiconductor substrate to be normal or not based on the test results.

In operation S255, when the data difference may be caused by the process problem, the semiconductor substrate may be scrapped.

In contrast, in operation S250, when the difference in data is located within the allowable range or caused by the system malfunction, the selected semiconductor substrate may be determined to be normal. A subsequent process may be performed on the semiconductor substrate determined to be normal.

In an exemplary embodiment of the present general inventive concept, the determination process may be remotely controlled by the worker. Thus, the worker may still work in a working area without going to and coming from a production line.

In operation S260, subsequent processes may be performed on the semiconductor substrate determined to be normal, thereby completing the semiconductor device.

According to this exemplary embodiment, the abnormal semiconductor device may be determined in the processes using the optical critical dimension database. Thus, performing the subsequent processes on the abnormal semiconductor device may be prevented. As a result, the yield of normal or non-defective semiconductor devices may be improved.

Further, the production line and the system may be electrically connected with each other, so that the robot may manage the production line. The worker may determine and manage the semiconductor substrate only when the problems may be generated, so that the production line may be effectively managed.

FIG. 10 is a block diagram illustrating a system to manufacture a semiconductor device.

Referring to FIG. 10, a system 300 of this exemplary embodiment may include a research area 310, a computation management area 320, a process management area 330 and a production area 340.

In an exemplary embodiment of the present general inventive concept, the research area 310 may include a plurality of personal terminals 315. Workers may research the semiconductor device. Further, the workers may solve problems in manufacturing the semiconductor device using the personal terminals 315.

The personal terminals 315 may display information of the semiconductor device. Thus, the information may be inputted into the personal terminals 315. Further, the information may be outputted from the personal terminals 315. The personal terminals 315 may be configured to receive/transfer the information in a network, e.g., by a wire or wireless network. The personal terminals 315 may include a desktop computer, a notebook computer, an ultra mobile personal computer, a portable multimedia player, etc.

The computation management area 320 may store data of the system 300. The computation management area 320 may manage and control the system 300.

In an exemplary embodiment of the present general inventive concept, the computation management area 320 may include a plurality of servers 325 capable of storing the data generated in the production area 340 and generating, storing and/or managing databases of the data.

The worker may read the data in the databases through the personal terminals 315.

The data in the databases may include process conditions, an optical critical dimension of a specific process, etc. The data in the databases may be converted into digital images.

The process management area 330 may include management units 334, 336 and 338 by unit processes 333, 335 and 337. Each of the management units 334, 336 and 338 may control each of the processes 333, 335 and 337.

The process management area 330 may be located adjacent to the production area 340. Further, the process management area 330 may be connected with the production area 340 through an automation line (not shown). Thus, semiconductor substrates may be automatically transferred between unit processes by the process management area 330.

The management units 334, 336 and 338 may have programs for performing loadings of the semiconductor substrates, measuring of the process conditions, comparing between samples and the semiconductor substrates, etc.

Further, the management units 334, 336 and 338 may have artificial intelligences for performing comparing and analyzing of the data to determine whether the semiconductor substrates may be normal or not and to direct the processes.

The production area 340 may include a plurality of unit processes 342, 344, 346, 348 and 349 where production equipments may be arranged. The semiconductor substrates may be automatically transferred between the unit processes 342, 344, 346, 348 and 349 by transfer machines.

Each of the semiconductor substrates may be labeled with individual identification numbers. States of the semiconductor substrates may be displayed on the management units 334, 336 and 338. Data of the semiconductor substrates may be stored in the servers 325.

Therefore, the management units 334, 336 and 338 may detect the states of the processes. The data of the processes may then be stored in the servers 325. The worker may read the data through the personal terminals 315.

A semiconductor device may be developed in the research area 310. Any one of the processes which may cause problems in the semiconductor device when vertical structures may not be aligned with each other may be selected. The selected process may be normally performed to obtain an optical critical dimension database.

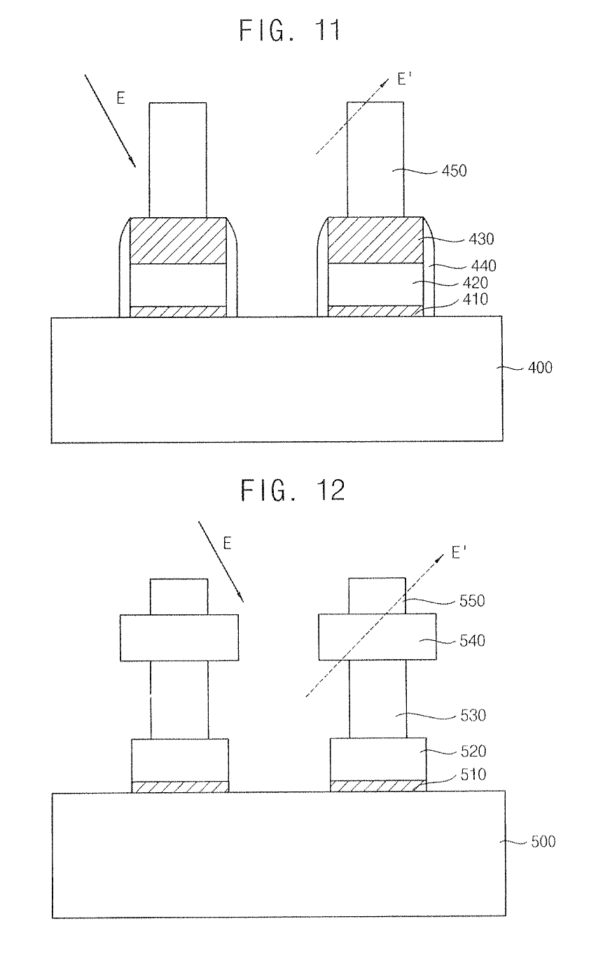

For example, referring to FIG. 11, a gate structure 410, 420 and 430 may be formed on a semiconductor substrate 400. An insulating interlayer (not shown) may be formed on the semiconductor substrate 400 to cover the gate structure 410, 420 and 430. The insulating interlayer may be etched to form an insulating interlayer pattern 450 having a contact hole.

Here, because the contact hole may be filled with a conductive material, it may be required to accurately connect the insulating interlayer pattern 450 with the gate structure 410, 420 and 430.

A semiconductor substrate having a contact hole that may accurately extend in an X-direction and a Y-direction may be selected. The semiconductor substrate may be irradiated by a light to generate a reflected light. Spectrum data may be obtained from the reflected light, as shown in FIGS. 8 and 9.

The spectrum data may be set as reference data. The reference data may be stored in the server 325.

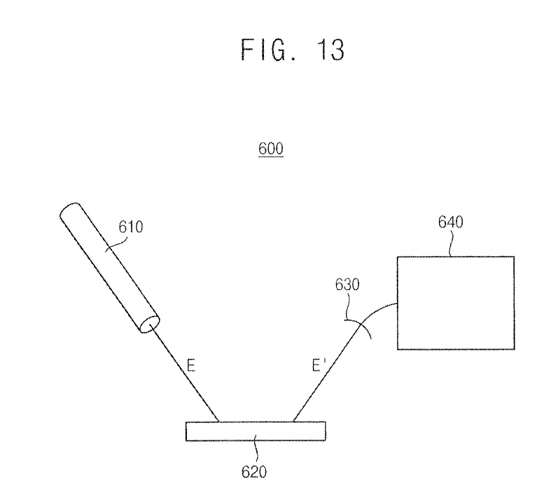

Further, for example, referring to FIG. 12, a gate structure 510 and 520 may be formed on a semiconductor substrate 500. A first metal wiring 530, a second metal wiring 540 and a third metal wiring 550 may be sequentially formed on the gate structure 510 and 520.

Here, a connection between the first, second and third metal wirings 530, 540 and 550 and the gate structure 510 and 520 may be an important factor influencing the electrical characteristics of the semiconductor device. Thus, it may be required to verify subsequent processes after forming the third metal wiring 550.

A semiconductor substrate having the metal wirings that may be accurately aligned with one another may be selected. The semiconductor substrate may be irradiated by a light to generate a reflected light. Spectrum data may be obtained from the reflected light, as shown in FIGS. 8 and 9.

The spectrum data may be set as reference data. The reference data may be stored in the server 325.

The semiconductor substrates may be loaded into the production area 340. The semiconductor substrates may be labeled with the individual identification numbers. The processes 342, 344, 346, 348 and 349 may be sequentially performed on the semiconductor substrates.

Here, the management units 334, 336 and 338 may check the states of the processes 342, 344, 346, 348 and 349. Data of the processes 342, 344, 346, 348 and 349 may be stored in the server 325.

The processes in FIGS. 11 and 12 may be performed on the semiconductor substrate. The semiconductor substrate may be loaded into the management units 334, 336 and 338. The spectrum data of the optical critical dimension of the semiconductor substrate may be measured.

The measured spectrum data may be compared with the reference spectrum data in the server 325.

When the measured spectrum data is substantially the same as the reference spectrum data, the semiconductor substrate may be transferred to a subsequent process lot. In contrast, when the measured spectrum data is different from the reference spectrum data, processes with respect to all of the semiconductor substrates may be suspended. This state may be displayed on the personal terminal 315.

The worker may determine whether the semiconductor substrate is normal or not based on the information displayed on the personal terminal 315. However, when the worker does not definitely determine whether the semiconductor substrate is normal or not from the information, the worker may determine based on data obtained from all of the semiconductor substrates.

In an exemplary embodiment of the present general inventive concept, the data may be displayed as an image on the personal terminal 315. Thus, the worker may determine in the research area 310 without going to and coming from the production area 340.

Further, the spectrum data may be transferred by a wire or wireless network. Therefore, the semiconductor production management may be remotely controlled, not only in the research area 310.

FIG. 13 is a block diagram illustrating a test tool used in manufacturing a semiconductor device.

Referring to FIG. 13, a test tool 600 of this exemplary embodiment may include a laser 610, a substrate 620, a light detecting unit 630, and a computer 640.

In an exemplary embodiment of the present general inventive concept, the laser 310 emits a light E onto the substrate 620. The reflected light E′ is detected by the light detecting unit 630. The computer 640 receives information from the light detecting unit 630 and compares the information to optical critical dimension data, stored internally or externally, to determine whether the substrate 620 is normal or abnormal.

In a conventional method, a failed or defective substrate between processes may not be recognized because the critical dimension may be measured using the SEM. Thus, an abnormal semiconductor device may be recognized in an electrical die sorting (EDS) process after processes for manufacturing the semiconductor device. As a result, subsequent processes may be still performed on the abnormal semiconductor device.

In contrast, the method of this exemplary embodiment may recognize the vertical profile of the patterns using the optical critical dimension. Thus, an abnormal semiconductor device may be recognized in the processes for manufacturing the semiconductor device to prevent the subsequent processes from being performed on the abnormal semiconductor device. As a result, the number of normally manufactured semiconductor devices may be more immediately recognized, so that product amounts of the semiconductor device may be more effectively controlled.

According to an exemplary embodiment of the present general inventive concept, an abnormal semiconductor device may be recognized in the processes for manufacturing the semiconductor device to prevent the subsequent processes from being performed on the abnormal semiconductor device. As a result, the yield of normal or non-defective semiconductor devices may be improved.

Although a few embodiments of the present invention have been shown and described, it would be appreciated by those skilled in the art that changes may be made in these embodiments without departing from the principles and spirit of the general inventive concept, the scope of which is defined in the claims and their equivalents.

1. A method of detecting an abnormal semiconductor device, the method comprising:
irradiating a pattern on a semiconductor substrate by a light;
detecting a reflected light from the pattern;
comparing spectrum data of the reflected light with a predetermined reference spectrum data that is obtained from a test pattern of a reference sample; and
determining whether the pattern is normal or not based on comparison results.

2. The method of claim 1, wherein the spectrum data and the reference spectrum data are obtained from optical critical dimensions of the pattern and the test pattern.

3. The method of claim 1, wherein the reference spectrum data is obtained from the test pattern on which a normal process is performed.

4. The method of claim 1, further comprising suspending a subsequent process on the semiconductor substrate that is determined to be abnormal.

5-10. (canceled)

11. A method of detecting an abnormal semiconductor device, the method comprising:
irradiating a pattern on a semiconductor substrate having a plurality of layers by a light;
detecting a reflected light from the pattern;
comparing spectrum data of the reflected light with a reference spectrum data that is obtained from a test pattern of a reference sample;
testing an additional semiconductor substrate; and
determining whether the pattern is normal or abnormal based on comparison results.

12. The method of claim 11, wherein the spectrum data and the reference spectrum data are obtained from optical critical dimensions of the pattern and the test pattern.

13. The method of claim 11, wherein the reference spectrum data is obtained from the test pattern on a normal semiconductor substrate on which a normal process is performed.

14. The method of claim 11, further comprising suspending a subsequent process on the semiconductor substrate that is determined to be abnormal.

15-20. (canceled)
